(19) United States
(12) Patent Application Publication
(10) Pub. No.: US 2026/0046613 A1
(43) Pub. Date: Feb. 12, 2026

(54) SECURITY SIGNATURES ADDED BY RECONFIGURABLE INTELLIGENT SURFACE (RIS) CONTROLLER ON RIS SURFACE

(71) Applicant: QUALCOMM Incorporated, San Diego, CA (US)

(72) Inventors: Ahmed ELSHAFIE, San Diego, CA (US); Alexandros MANOLAKOS, Athens (GR); Hung Dinh LY, San Diego, CA (US); Yu ZHANG, San Diego, CA (US); Wanshi CHEN, San Diego, CA (US); Peter GAAL, San Diego, CA (US)

(21) Appl. No.: 18/998,995

(22) PCT Filed: Sep. 12, 2023
(86) PCT No.: PCT/US2023/073979

§ 371 Date: Jan. 27, 2025

(30) Foreign Application Priority Data
Sep. 26, 2022 (GR) 20220100787

(51) Int. Cl. H04W 12/037; H04L 9/32

(52) U.S. Cl. CPC H04W 12/037; H04L 9/3247

(57) ABSTRACT

Certain aspects of the present disclosure provide a method for wireless communications at a controller. The controller obtains, from a network entity, signaling indicating a configuration for a security signature for at least one reconfigurable intelligent surface (RIS). The controller configures the at least one RIS according to the security signature.

### CROSS-REFERENCE TO RELATED APPLICATION(S)

This application claims priority to Greece Patent Application No. 20220100787, filed Sep. 26, 2022, which is hereby incorporated by reference herein.

### BACKGROUND

### Field of the Disclosure

Aspects of the present disclosure relate to wireless communications, and more particularly, to techniques for managing secure communications in a reconfigurable intelligent surface (RIS) based wireless communications system.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a controller. The method includes obtaining, from a network entity, signaling indicating a configuration for a security signature for at least one reconfigurable intelligent surface (RIS); and configuring the at least one RIS according to the security signature.

Another aspect provides a method for wireless communications at a user equipment (UE). The method includes obtaining, from a network entity, signaling indicating a secret-key; obtaining, from the network entity, an artificial noise (AN) signal; obtaining, from the network entity, a data signal via an RIS; and decoding the obtained data signal and the obtained AN signal, in accordance with the secret-key.

Another aspect provides a method for wireless communications at a network entity. The method includes determining a secret-key shared among at least two of the network entity, a UE, and a controller of at least one RIS; generating AN signal, in accordance with the secret-key; and outputting the AN signal for transmission to the UE.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIGS. 4A, 4B, 4C, and 4D depict various example aspects of data structures for a wireless communications network.

FIG. 5 depicts example blockage blocking transmissions between wireless communication devices.

FIG. 6 depicts example operation of a reconfigurable intelligent surface (RIS) in an RIS-based wireless communications system.

FIG. 7 depicts example RIS with a fixed RIS configuration in an RIS-based wireless communications system.

FIG. 8 depicts example RIS with an RIS configuration that is changing over time in an RIS-based wireless communications system.

FIG. 9 depicts example attack by a potential attacker UE in an RIS-based wireless communications system.

FIG. 10 depicts example protected and unprotected channels and layers in an RIS-based wireless communications system.

FIG. 11 depicts a call flow diagram illustrating example communication among a controller associated with one or more RISs, a UE and a network entity.

FIGS. 12-13 depict example communications among a controller of an RIS, one or more UEs and a network entity in an RIS-based wireless communications system.

FIGS. 14-16 depict example beamforming of different signals on different resource elements (REs) in an RIS-based wireless communications system.

FIG. 17 depicts a method for wireless communications at a controller.

FIG. 18 depicts a method for wireless communications at a UE.

FIG. 19 depicts a method for wireless communications at a network entity.

FIGS. 20-22 depict aspects of example communications devices.

### DETAILED DESCRIPTION

Aspects of the present disclosure provide apparatuses, methods, processing systems, and computer-readable mediums for managing secure communications in a reconfigurable intelligent surface (RIS) based wireless communications system.

In some wireless communications systems, communication channels and/or devices may not be protected, which may result in insecure communications (i.e., communications are susceptible to interception). For example, in an RIS-based wireless communications system, some devices (e.g., an RIS controller of an RIS) may not have any upper layer security, which may result in the insecure communications. Also, in this system, some communication channels and/or layers may not be protected or secured. For example, downlink and uplink communications supported by a physical (PHY) layer may not be protected. Accordingly, in such systems, a potential attacker user equipment (UE) is able to attack the RIS and/or a network entity, which may result in the insecure communications between devices of this system. Therefore, there is a need for techniques to enable the secure communications in the RIS-based wireless communications system.

Aspects of the present disclosure provide techniques for enabling secure communications in an RIS-based wireless communications system. For example, to improve PHY layer security, a controller of an RIS, a UE, and/or a network entity of the RIS-based wireless communications system may agree on a secret-key. The controller may receive a signal from a transmitter device such as the network entity. The controller may add a secret-key based random signature (e.g., apply random amplitude or phase) to the received signal, which is then reflected from a surface of the RIS towards a receiver device such as the UE. Since the UE also has the secret-key, the UE is able to decode the signal received from the RIS based on the secret-key. However, in some cases, if the RIS reflects the signal towards an illegitimate receiver device, the illegitimate receiver device will not be able to decode the received signal, since the illegitimate receiver device does not have the secret-key.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

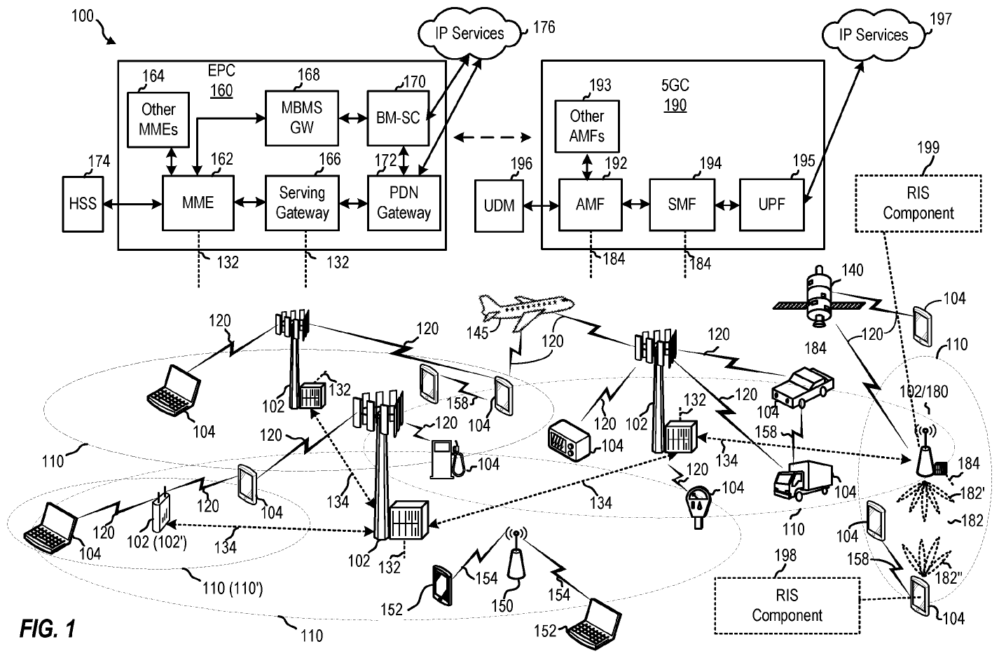

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

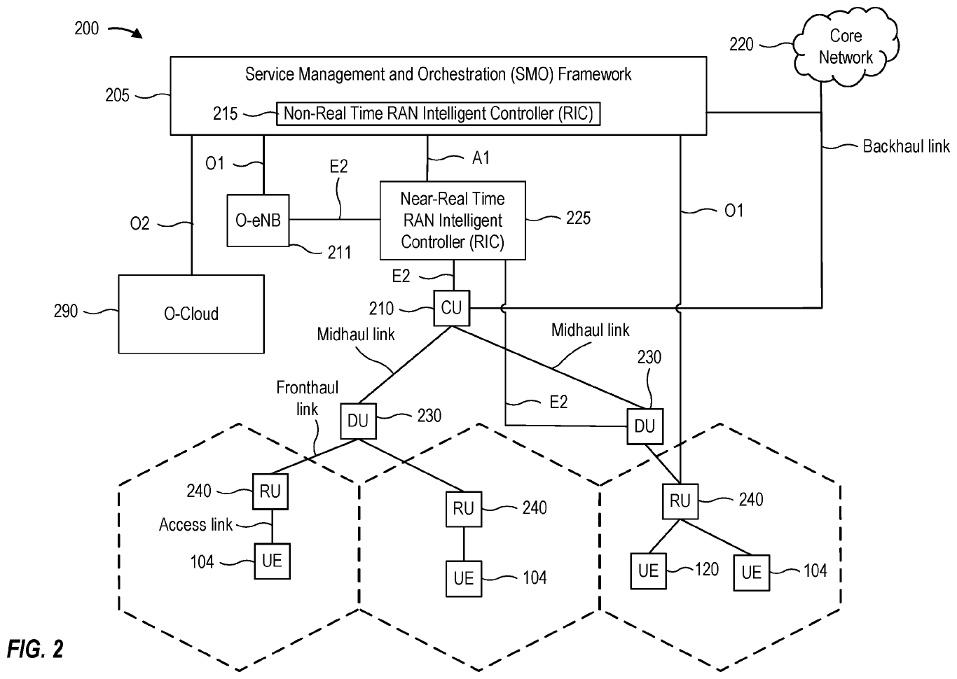

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mm Wave”). A BS configured to communicate using mm Wave/near mm Wave radio frequency bands (e.g., a mm Wave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

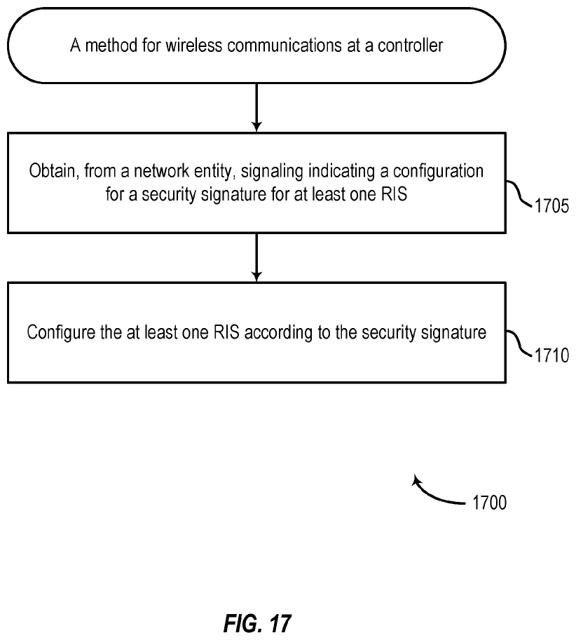

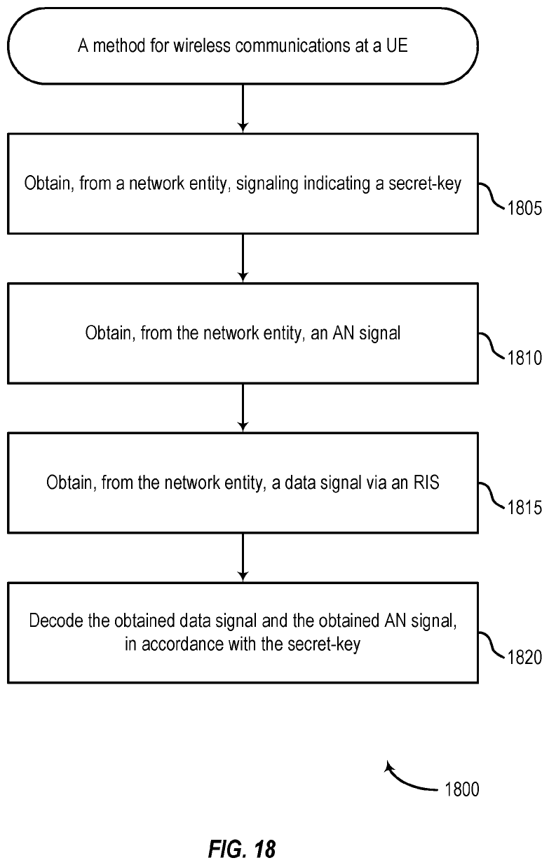

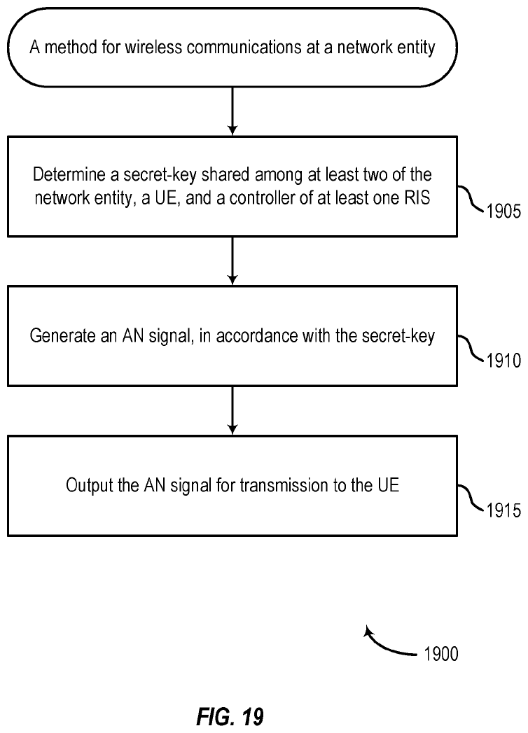

Wireless communication network 100 further includes reconfigurable intelligent surface (RIS) component 198, which may be configured to perform methods 1700 of FIG. 17 and/or 1800 of FIG. 18. Wireless communication network 100 further includes RIS component 199, which may be configured to perform methods 1700 of FIG. 17 and/or 1900 of FIG. 19.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

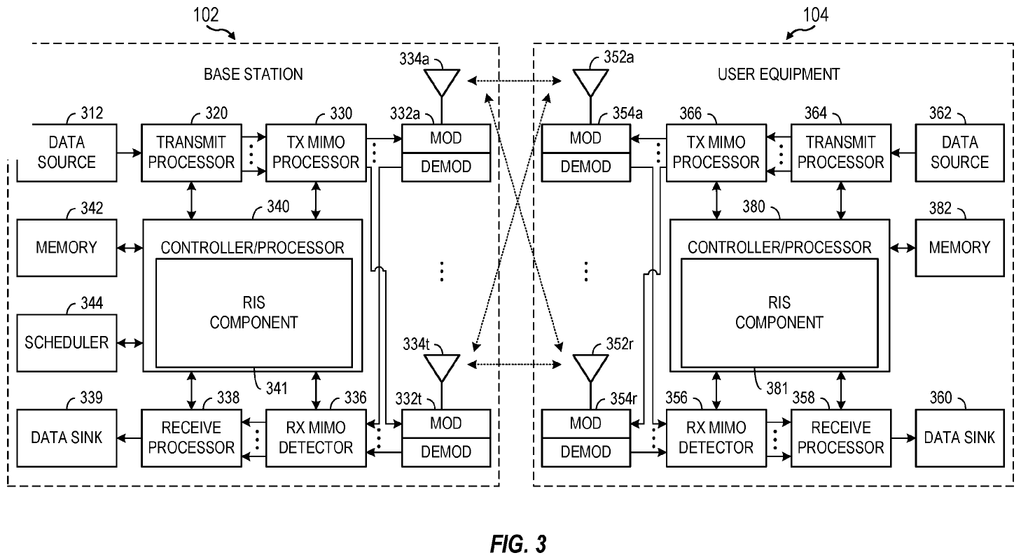

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes RIS component 341, which may be representative of RIS component 199 of FIG. 1. Notably, while depicted as an aspect of controller/processor 340, RIS component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes RIS component 381, which may be representative of RIS component 198 of FIG. 1. Notably, while depicted as an aspect of controller/processor 380, RIS component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

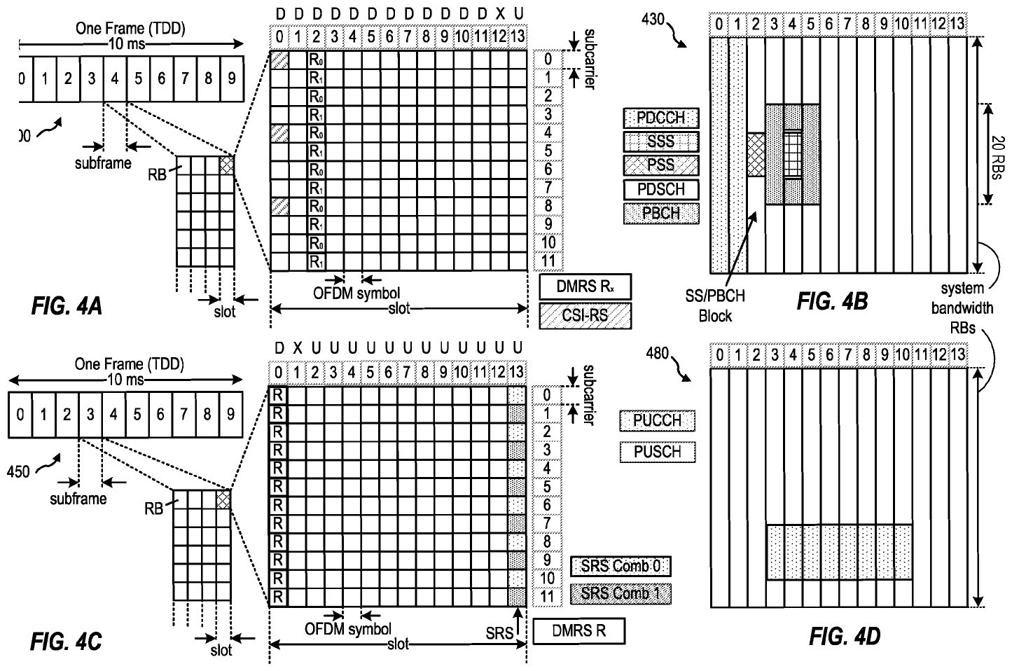

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3rd generation partnership project (3GPP) standards. For example, 3GPP technical standard TS 38.101 currently defines Frequency Range 1 (FR1) as including 600 MHz-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mm Wave/near mm Wave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Overview of Layer 2 (L2) of New Radio (NR) Protocol Stock

New radio (NR) protocol stack has two categories: 1) control-plane stack, and 2) user-plane stack. If data corresponds to signaling or controlling message, then the data is sent through the control-plane. User data is sent through the user-plane.

User-plane protocol stock (e.g., layer 2 (L2)) of NR is split into sub layers such as a service data adaptation protocol (SDAP) layer, a packet data convergence protocol (PDCP) layer, a radio link control (RLC) layer, and a medium access control (MAC) layer. In NR, carrier aggregation is supported, and data for each carrier may be processed independently in the SDAP layer, the PDCP layer, the RLC layer and is multiplexed in the MAC layer.

The SDAP layer may perform mapping between a quality of service (QoS) flow (e.g., associated with one or more packets (e.g., protocol data units (PDUs)) and a data radio bearer (DRB) (e.g., due to QoS framework). The SDAP layer may also perform marking QoS flow ID (QFI) in both downlink and uplink packets (e.g., downlink due to reflective QoS and uplink due to QoS framework). A single protocol entity of SDAP is configured for each individual protocol data unit (PDU) session.

The PDCP layer may perform header compression and decompression of internet protocol (IP) data (e.g., robust header compression (ROHC)), maintain PDCP sequence numbers (SNs), perform in-sequence delivery of upper layer PDUs at re-establishment of lower layers, perform reordering and eliminate duplicates of lower layer service data units (SDUs), execute PDCP PDU routing for the case of split bearers, execute retransmission of lower layer SDUs, cipher and decipher control plane and user-plane data, perform integrity protection and integrity verification of control plane and user plane data, control timer-based discard of data, and perform security operations (e.g., ciphering, deciphering, integrity protection, integrity verification, etc.).

The RLC layer may operate in a plurality of modes of operation including transparent mode (TM), unacknowledged mode (UM), and acknowledged mode (AM). The RLC layer may perform transfer of upper layer PDUs error correction through automatic repeat request (ARQ) for AM data transfers, and segmentation and reassembly of RLC SDUs for UM and AM data transfers. The RLC layer may maintain SNs independent of the ones in PDCP for UM and AM data transfers. The RLC layer may perform resegmentation of RLC data PDUs for AM data transfers, detect duplicate data for AM data transfers, discard RLC SDUs for UM and AM data transfers, detect protocol errors for AM data transfers, and/or perform RLC re-establishment.

The MAC layer may perform mapping between logical channels and transport channels, multiplexing of MAC SDUs from one or more logical channels onto transport blocks (TB) to be delivered to a physical (PHY) layer via transport channels, de-multiplexing MAC SDUs to one or more logical channels from TB delivered from the PHY layer via the transport channels, scheduling information reporting, error correction through hybrid automatic repeat request (HARQ), priority handling between user equipments (UEs) by means of dynamic scheduling, priority handling between logical channels of one UE by means of logical channel prioritization, and/or padding.

The PHY layer sits at a bottom of the NR protocol stack, interfacing to a MAC sublayer higher up via transport channels. The PHY layer provides its services to the MAC layer. The PHY layer supports downlink (gNB-to-UE), uplink (UE-to-gNB) and sidelink (UE-to-UE) communications.

### Overview of Massive Multiple Input Multiple Output (MIMO)

5^{th} generation (5G) new radio (NR) massive multiple input multiple output (MIMO) is an extension of MIMO, which groups together antennas (e.g., at a transmitter device and a receiver device) to provide better throughput and spectrum efficiency. The massive MIMO expands beyond conventional systems by adding a much higher number of antennas. The higher number of antennas helps focus energy, which brings drastic improvements in throughput and efficiency. Along with the increased number of antennas, both network and user equipments (UEs) implement more complex designs to coordinate MIMO operations. The benefits of the massive MIMO to the network and the UEs may include increased network capacity and improved coverage.

Although there are several benefits of the massive MIMO, there are also some challenges associated with the massive MIMO. For example, since a high beamforming gain is achieved by using active antenna units (AAUs), which may include power consuming hardware (e.g., individual radio frequency (RF) chains per antenna port), there is a significant increase in power consumption due to the use of AAUs.

### Overview of Reconfigurable Intelligent Surface (RIS)

As noted above, massive multiple input multiple output (MIMO) configuration increases throughput. For example, MIMO may achieve a high beamforming gain by using active antenna units (AAUs) and may operate with individual radio frequency (RF) chains for each antenna port. Unfortunately, the use of the AAUs may significantly increase power consumption.

To further such advantages and extend coverage, reconfigurable (or reflective) intelligent surfaces (RISs) may be deployed to reflect impinging beams/signals in desired directions. In some cases, the RISs may operate without the substantial power consumption when operating passively to only reflect or refract signals from a transmitter device towards a receiver device. In some cases, the reflection or refraction direction may be controlled by a network entity or a monitoring user equipment (UE).

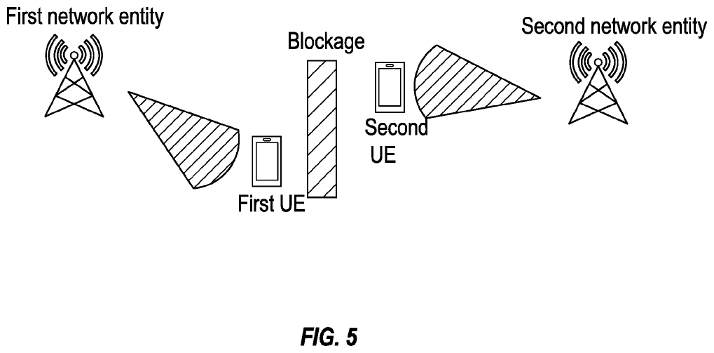

FIG. 5 illustrates an example of a communication blockage between wireless communication devices. As shown, impeded by the blockage, a first network entity may only transmit to a first UE and may not reach a second UE, as the blockage prevents signals from reaching the second UE. Also, a second network entity may only transmit to the second UE and may not reach the first UE, as the blockage prevents the signals from reaching the first UE. The blockage also prevents the first UE from establishing sidelink communications with the second UE. As such, the second UE may not be able to communicate with the first network entity or the first UE, and the first UE may not be able to communicate with the second network entity or the second UE.

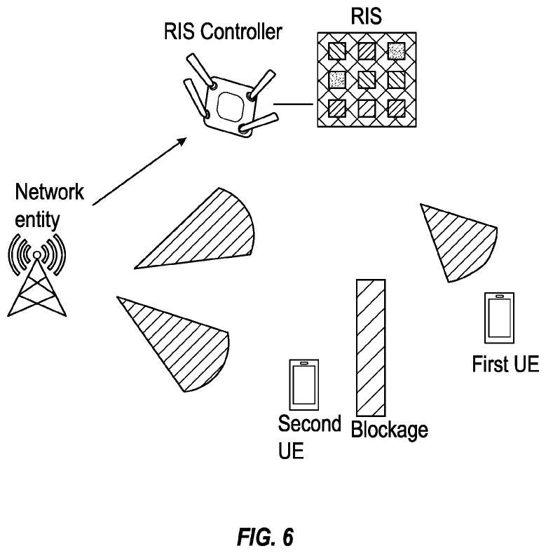

FIG. 6 illustrates an example case of using an RIS to overcome a blockage in an RIS-based wireless communications system. As shown, the RIS may be introduced to reflect or otherwise re-radiate radio signals to bypass the blockage. For example, communications between a network entity and a first UE may be enabled by the RIS re-radiating one or more signals from the network entity towards the first UE and vice versa. Furthermore, the RIS can also be reconfigured (i.e., directing incoming and outgoing beams at different angles) to enable a second UE and the first UE to establish sidelink communications.

In some cases, an RIS may be a full-duplex (FD) device. FD communication allows for simultaneous transmission between devices. Half-duplex (HD) communication flows in one direction at a time. In operation, the RIS may immediately reflect a received signal from a transmitter device to a receiver device.

In some cases, an RIS may perform passive beamforming. For example, the RIS may receive signal power from a transmitter device proportional to a number of elements such as RIS elements of the RIS. When the RIS reflects or refracts a radio signal, one or more RIS elements may cause phase shifts to perform the beamforming or precoding. The phase shifts may be based on precoding weights (e.g., a multiplier or an offset of a time delay) applied to the one or more RIS elements. In some cases, for an array of RIS elements of the RIS, an RIS controller of the RIS may generate or specify a precoding weight for each RIS element.

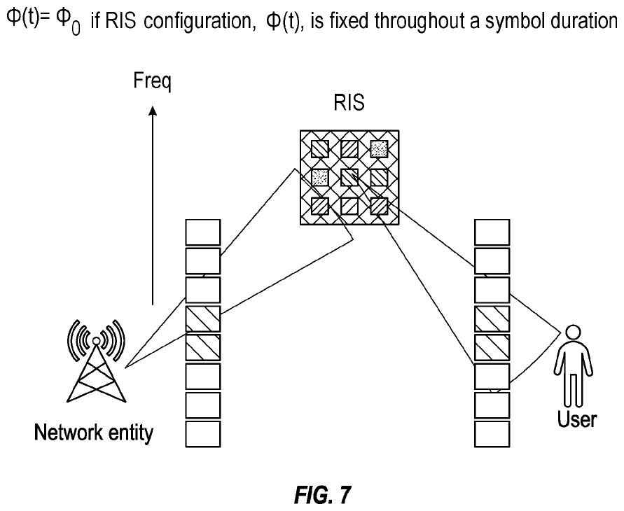

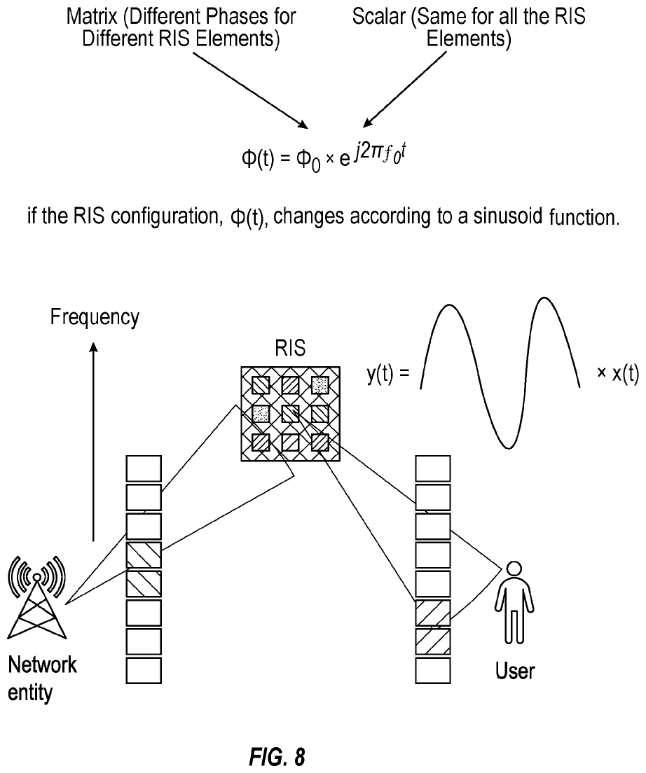

In some RIS-based wireless communications systems, as illustrated in FIG. 7, an RIS configuration (e.g., phase, amplitude, etc. of RIS elements) of an RIS may remain fixed during operation (e.g., throughout a duration of a symbol). In some other RIS-based wireless communications systems, as illustrated in FIG. 8, the RIS configuration of the RIS may change. For example, the phase of the RIS elements may change according to a sinusoid function. In such systems where the RIS configuration of the RIS is changed over time, a signal reflected by the RIS can be shifted in a frequency domain.

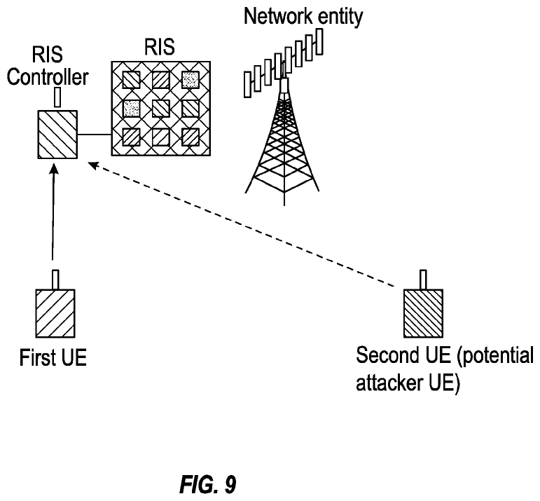

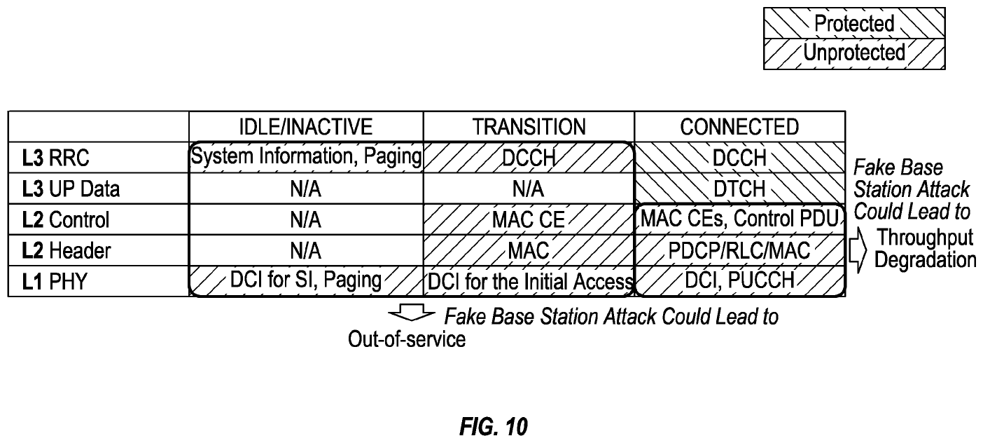

In wireless communications systems, secure communications are important. Secure communication is when two devices are communicating and do not want a third party device to listen in. For this to be the case, the devices need to communicate in a way that is unsusceptible to eavesdropping or interception. To enable the secure communications, communication channels and/or devices of the wireless communications systems are protected. However, in some wireless communications systems, the communication channels and/or the devices may not be protected, which may result in insecure communications. For example, in an RIS-based wireless communications system illustrated in FIG. 9, some devices (e.g., an RIS controller of an RIS) may not have any upper layer security, which may result in the insecure communications between various devices of this system. Also, in this system, some communication channels and/or layers, as illustrated in FIG. 10, may not be protected or secured. For example, downlink and uplink communications supported by a physical (PHY) layer may not be protected. Accordingly, in such systems, a potential attacker UE (e.g., UE2 illustrated in FIG. 9) is able to attack an RIS and/or a network entity, which may result in the insecure communications between the devices of this system. Therefore, there is a need for techniques to enable the secure communications in the RIS-based wireless communications system.

### Aspects Related to Security Signature Added by RIS Controller on RIS Surface

Aspects of the present disclosure provide apparatuses, methods, processing systems, and computer-readable mediums for managing secure communications in a reconfigurable intelligent surface (RIS) based wireless communications system.

For example, to improve physical (PHY) layer security, a controller of an RIS, a user equipment (UE), and/or a network entity of the RIS-based wireless communications system may agree on a secret-key. The controller may receive a signal from a transmitter device such as the network entity. The controller may add a secret-key based random signature (e.g., apply random amplitude or phase) to the received signal, which is then reflected from a surface of the RIS towards a receiver device such as the UE. Since the UE also has the secret-key, the UE is able to decode the received signal from the RIS based on the secret-key. In some cases, if the RIS reflects the signal towards an illegitimate receiver device, the illegitimate receiver device will not be able to decode the received signal since the illegitimate receiver device does not have the secret-key. The signal maybe a data signal or a reference signal (e.g., channel state information (CSI)-reference signal, demodulation reference signal, etc.).

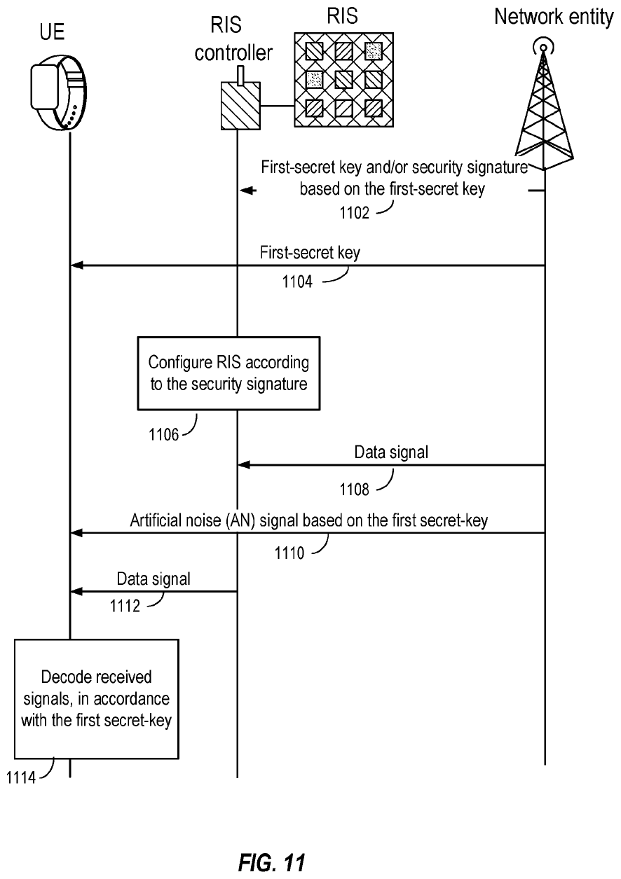

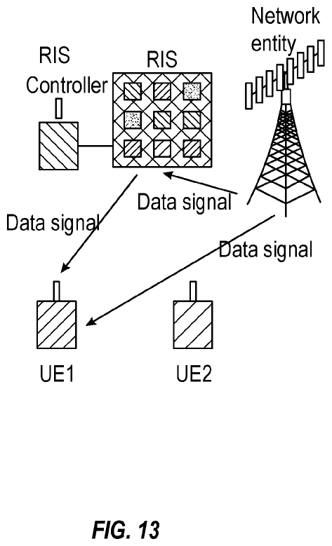

Techniques proposed herein enable secure communications and may be understood with reference to FIGS. 11-19.

As illustrated in FIG. 11, at 1102, a network entity (e.g., such as gNodeB (gNB) or BS 102 in wireless communication network 100 of FIG. 1) sends signaling indicating a first secret-key and/or a configuration for a security signature for an RIS to a controller of the RIS. In some cases, the controller may be associated with more than one RIS.

In certain aspects, the signaling may be layer 1, layer 2, or layer 3 signaling. In certain aspects, the network entity may be a pico cell, a micro cell, a macro cell, a relay node, an integrated access and backhaul (IAB) node, a radio access network (RAN) node, or a non-RAN node.

In certain aspects, the network entity may determine one or more secret-keys (e.g., the first secret-key, a second secret-key, a third secret-key, and a fourth secret-key). Some of these secret-keys may be same or different from each other. In certain aspects, the network entity along with the controller and a UE (e.g., such as UE 104 in wireless communication network 100 of FIG. 1) may determine (e.g., based on inputs from each other) and agree on the one or more secret-keys. The network entity may then determine the security signature for the RIS based on at least one secret-key. For example, the security signature may be a random signature based on the first secret-key.

In certain aspects, the UE may be a sidelink UE, a programmable logic controller (PLC), a remote UE, or a customer premise equipment (CPE).

At 1104, the network entity sends the signaling indicating the first secret-key to the UE. In certain aspects, the network entity may send the signaling indicating the configuration for the security signature to the UE.

At 1106, the controller configures the RIS according to the security signature. For example, by indication of a secure mode to the controller and other wireless nodes (e.g., the UE), to improve PHY layer security, the controller may add the first secret-key based random signature to a reflected signal from a surface of the RIS (i.e., add the first secret-key based random signature to one or more beams generated by the controller).

In certain aspects, the controller may select an RIS beamformer from a set of RIS beamformers, in accordance with the security signature. For example, the controller may set a random RIS beamformer and/or RIS configuration (e.g., phase, amplitude, etc. of RIS elements) of the RIS. In another example, the controller may randomly select the random RIS beamformer from the set of RIS beamformers, which may result in a good performance for a legitimate receiver device (e.g., the UE) receiving and decoding a signal from the controller.

In certain aspects, the controller may select at least one of an amplitude value or a phase value of one or more elements of the RIS, in accordance with the security signature. For example, the controller may set a random amplitude value and/or the phase value (e.g., a complex scale of these values) on the surface of the RIS. The surface may include multiple RIS elements.

In certain aspects, the controller may change at least one of the amplitude value or the phase value of the one or more elements of the RIS over a duration of at least one symbol, in accordance with the security signature. For example, a single complex scale (e.g., phase, amplitude, etc.) across all the RIS elements on the surface of the RIS may change slowly (e.g., over at least one orthogonal frequency division multiplexing (OFDM) symbol duration). In some cases, the RIS configuration Φ(t)=Φ₀×α(t)e^{j2πf}^{₀}^{t} where f₀ is random and is based on the first secret-key.

In certain aspects, the controller may change at least one of the amplitude value or the phase value of the one or more elements of the RIS within a first duration of a symbol or a second duration between two symbols, in accordance with the security signature. For example, the single complex scale across all the RIS elements on the surface of the RIS may change quickly (e.g., within a single OFDM symbol duration or from one OFDM symbol to other OFDM symbol) and may result in a frequency error on an entire data block or each piece of data block. In some cases, when Φ(t)=Φ₀×α(t)e^{j2πf}^{₀}^{t} from t₁ to t₂, then Φ(t)=Φ₀×e^{j2πf}^{₁}^{t} from t₂ to t₃, etc. In this case, processing of a signal at the legitimate receiver device, which is received from the controller, may occur in a time domain to remove a random phase time ramp from the receive signal.

In certain aspects, the controller may change at least one of the amplitude value or the phase value of the one or more elements of the RIS each sample time, in accordance with the security signature. For example, a random complex scale (e.g., phase, amplitude, etc. of RIS elements) may change each sample time, i.e., Φ(t)=Φ₀×α(t)e^{jγ(t)} where γ(t) is a random phase that changes each t and α(t) is a random amplitude that changes each t.

In certain aspects, the controller may change at least one of the amplitude value or the phase value of the one or more elements of the RIS every block of symbols, in accordance with the security signature. For example, the security signature may change every sample or a block of symbols. In this case, |α(t)e^{jγ(t)}|=|α(t) cos(γ(t))+jα(t)sin(γ(t)|=α(t). α(t)=1 and γ(t) either It or zero every t or every interval t1 to t2 or every OFDM symbol duration or a set of OFDM symbols. α(t)∈{−1,1} and γ(t)=0 every t or every interval t1 to t2 or every OFDM symbol duration.

In certain aspects, the controller may change the phase value of the one or more elements of the RIS based on the first secret-key and the amplitude value of the one or more elements of the RIS based on the second secret-key. For example, amplitude α(t) may be generated based on the second secret-key, and the first secret-key may be used to generate phase change ι(t) or fₓ where x={0,1,2 . . . }. The legitimate receiver device such as the UE may remove these complex values (e.g., the amplitude and phase values) before decoding received signals, since the legitimate receiver device may know the complex values. In some cases, decoding of the received signals at an illegitimate receiver device (e.g., which does not have the first secret-key) may not be possible since these complex values may not be known to the illegitimate receiver device and as a result coherent detection is not possible.

In certain aspects, the controller may randomly turn ON or OFF one or more elements of the RIS, in accordance with the security signature. The controller may select at least one of an amplitude value or a phase value of the one or more elements that are turned ON, in accordance with the security signature.

In certain aspects, the controller may randomly turn ON or OFF one or more other RISs in accordance with the security signature. The controller may select at least one of an amplitude value or a phase value of one or more elements of the one or more other RISs that are turned ON, in accordance with the security signature. For example, when there are multiple RISs controlled by one or more controllers, the controller may randomly set one or more RISs or RIS elements ON/OFF and/or select complex values/phase ramps to be used on each RIS/RIS element, based on one or more secret-keys. In one example, the controller may use the first secret-key to set the one or more RISs ON or OFF. In another example, the controller may use the second secret-key to set RIS elements within an RIS ON or OFF. In another example, the controller may use the third secret-key for complex parameter change (alpha(t) and gamma(t)) of the RIS. In another example, the controller may use the fourth secret-key to determine how fast parameters (such as amplitude and phase) of the RIS may change.

In certain aspects, the network entity may beamform different signals on different resource elements (REs). The different signals may be one or more data signals and one or more artificial noise (AN) signals.

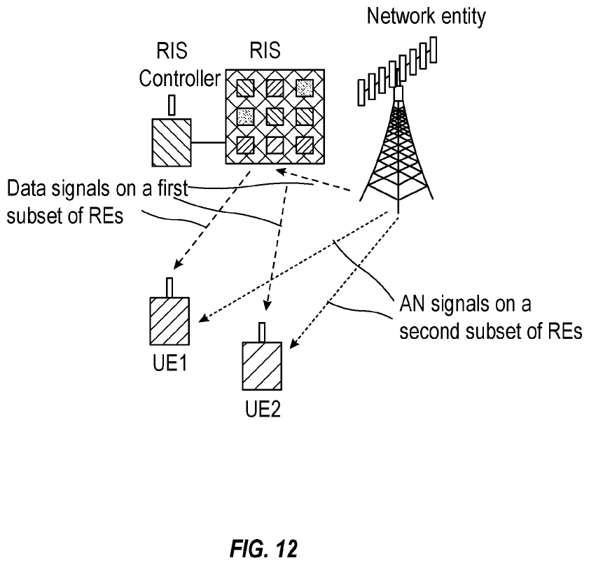

For example, at 1108, the network entity transmits the one or more data signals. In one example, as illustrated in FIGS. 12-14, the network entity may generate and transmit a data signal, on a first subset of REs of a set of REs, in a direction of the surface of the RIS. The controller receives the data signal.

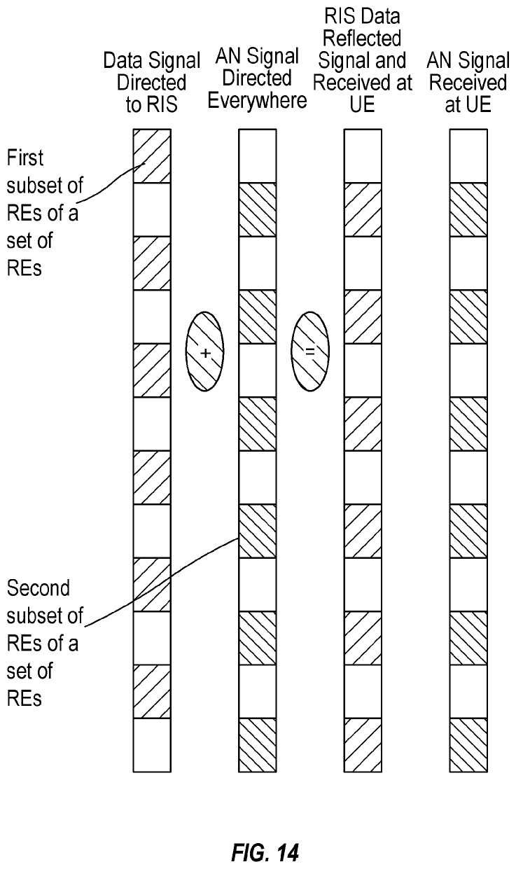

Referring back to FIG. 11, at 1110, the network entity transmits the one or more AN signals. For example, the network entity may generate (e.g., based on the first secret-key) and then transmit AN signal on a second subset of REs of the set of REs, in a direction of the legitimate receiver device such as the UE. In another example, as illustrated in FIGS. 12 and 14, the network entity may generate (e.g., based on one or more secret-keys) and then transmit multiple AN signals, on the second subset of REs of the set of REs, to multiple UEs (such as UE1 and UE2). Each of these multiple UEs may receive at least one AN signal, and a legitimate UE may cancel the received at least one AN signal since the legitimate UE may know the one or more secret-keys.

In certain aspects, the first subset of REs may be same as the second subset of REs.

In certain aspects, the network entity may transmit the AN signal orthogonal to a direction of the UE. For example, the AN signal may be beamformed orthogonal to a direction of the legitimate UE, but still generated based on the first secret-key, so that any potential residual interference can be removed.

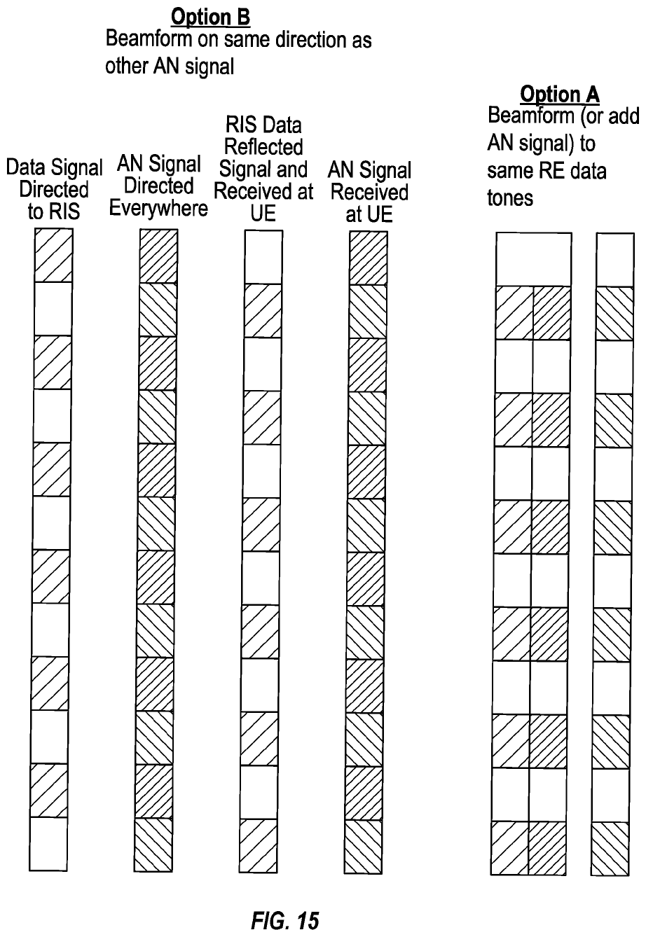

In certain aspects, as illustrated in option A of FIG. 15, the AN signal may be added to REs associated with the data signal. For instance, beamform (or add the AN signal) to same RE data tones corresponding to the first subset of REs. In this example case, a resultant signal may be a combination of multiple signals (e.g., three signals) concentrated and/or received on same REs. This will increase security of transmissions, however, in some cases, this may also result in increased power consumption due to the injection of the AN signal.

In certain aspects, the network entity may transmit the AN signal in a same direction as other AN signals. For example, as illustrated in option B of FIG. 15, the AN signal may be added to REs associated with the data signal, such that the AN signal may be beamformed in a same direction as other AN signals to all locations except a location of the controller.

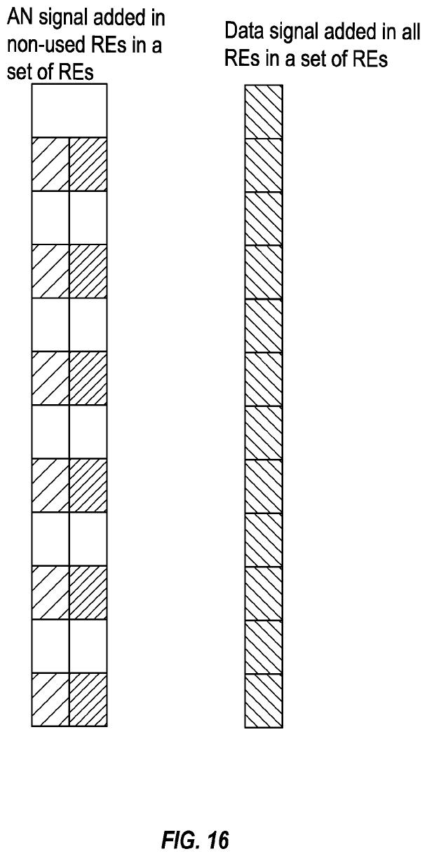

In certain aspects, the network entity may transmit the AN signal on non-used REs of the set of REs. For example, as illustrated in FIG. 16, the AN signal may be added to the non-used REs (of the first subset of REs and/or the second subset of REs) to further confuse any attacker UE so that the attacker UE do not know where data is.

In certain aspects, as further illustrated in FIG. 16, the data signal may be added in all REs of the set of REs.

Referring back to FIG. 11, at 1112, the controller transmits/reflects the received data signal to the UE. For example, the controller may apply a time phase ramp to shift a frequency domain of the data signal to overlap or align with a frequency domain of another signal, in accordance with the first secret-key. The other signal may the AN signal.

In certain aspects, the time phase ramp and/or a location of the data signal and/or the AN signal are agreed among the network entity, the UE, and/or the controller. For example, the network entity, the UE, and/or the controller may determine and agree on the time phase ramp to be used at the controller and where the data and AN signals are located, to align all these signals for the UE to decode.

At 1114, the UE decodes the received data signal and the received AN signal, in accordance with the first secret-key. For example, during the decoding process, the UE may cancel the received AN signal since the UE knows the first secret-key, which was used to generate the AN signal.

### Example Operations of a Controller

FIG. 17 shows an example of a method 1700 for wireless communications at a controller.

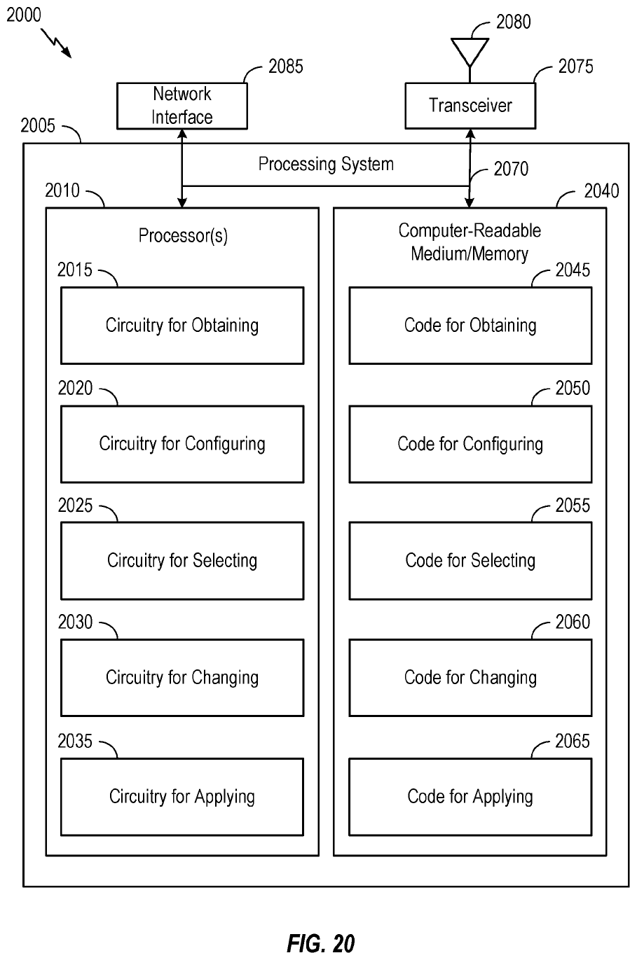

Method 1700 begins at step 1705 with obtaining, from a network entity, signaling indicating a configuration for a security signature for at least one RIS. In some cases, the operations of this step refer to, or may be performed by, circuitry for obtaining and/or code for obtaining as described with reference to FIG. 20.

Method 1700 then proceeds to step 1710 with configuring the at least one RIS according to the security signature. In some cases, the operations of this step refer to, or may be performed by, circuitry for configuring and/or code for configuring as described with reference to FIG. 20.

In some aspects, the security signature is a random signature based on a first secret-key.

In some aspects, the first secret-key is agreed among at least two of the controller, the network entity, and a UE.

In some aspects, the method 1700 further includes obtaining a data signal from the network entity. In some cases, the operations of this step refer to, or may be performed by, circuitry for obtaining and/or code for obtaining as described with reference to FIG. 20.

In some aspects, the method 1700 further includes applying a time phase ramp to shift a frequency domain of the data signal to overlap or align with a frequency domain of another signal, and wherein the other signal is AN signal. In some cases, the operations of this step refer to, or may be performed by, circuitry for applying and/or code for applying as described with reference to FIG. 20.

In some aspects, the obtaining comprises obtaining the data signal from the network entity on a first subset of REs of a set of REs; the AN signal is obtained via a second subset of REs of the set of REs; and/or the AN signal is also based on the first secret-key.

In some aspects, at least one of the time phase ramp or a location of the data signal and the AN signal are agreed among the network entity, the UE, and the controller.

In some aspects, the method 1700 further includes selecting an RIS beamformer from a set of RIS beamformers, in accordance with the security signature. In some cases, the operations of this step refer to, or may be performed by, circuitry for selecting and/or code for selecting as described with reference to FIG. 20.

In some aspects, the method 1700 further includes selecting at least one of an amplitude value or a phase value of one or more elements of the at least one RIS, in accordance with the security signature. In some cases, the operations of this step refer to, or may be performed by, circuitry for selecting and/or code for selecting as described with reference to FIG. 20.

In some aspects, the method 1700 further includes changing at least one of the amplitude value or the phase value over a duration of at least one symbol, in accordance with the security signature. In some cases, the operations of this step refer to, or may be performed by, circuitry for changing and/or code for changing as described with reference to FIG. 20.

In some aspects, the method 1700 further includes changing at least one of the amplitude value or the phase value within a first duration of a symbol or a second duration between two symbols, in accordance with the security signature. In some cases, the operations of this step refer to, or may be performed by, circuitry for changing and/or code for changing as described with reference to FIG. 20.

In some aspects, the method 1700 further includes changing at least one of the amplitude value or the phase value each sample time, in accordance with the security signature. In some cases, the operations of this step refer to, or may be performed by, circuitry for changing and/or code for changing as described with reference to FIG. 20.

In some aspects, the method 1700 further includes changing at least one of the amplitude value or the phase value every block of symbols, in accordance with the security signature. In some cases, the operations of this step refer to, or may be performed by, circuitry for changing and/or code for changing as described with reference to FIG. 20.

In some aspects, the method 1700 further includes changing the phase value based on the first secret-key. In some cases, the operations of this step refer to, or may be performed by, circuitry for changing and/or code for changing as described with reference to FIG. 20.

In some aspects, the method 1700 further includes changing the amplitude value across based on a second secret-key, wherein the second secret-key is different than the first secret-key. In some cases, the operations of this step refer to, or may be performed by, circuitry for changing and/or code for changing as described with reference to FIG. 20.

In some aspects, the method 1700 further includes randomly turning ON or OFF one or more elements of the at least one RIS, in accordance with the security signature. In some cases, the operations of this step refer to, or may be performed by, circuitry for configuring and/or code for configuring as described with reference to FIG. 20.

In some aspects, the method 1700 further includes selecting at least one of an amplitude value or a phase value of the one or more elements that are turned ON, in accordance with the security signature. In some cases, the operations of this step refer to, or may be performed by, circuitry for selecting and/or code for selecting as described with reference to FIG. 20.

In some aspects, the method 1700 further includes randomly turning ON or OFF one or more other RISs in accordance with the security signature. In some cases, the operations of this step refer to, or may be performed by, circuitry for configuring and/or code for configuring as described with reference to FIG. 20.

In some aspects, the method 1700 further includes selecting at least one of an amplitude value or a phase value of one or more elements of the one or more other RISs that are turned ON, in accordance with the security signature. In some cases, the operations of this step refer to, or may be performed by, circuitry for selecting and/or code for selecting as described with reference to FIG. 20.

In one aspect, method 1700, or any aspect related to it, may be performed by an apparatus, such as communications device 2000 of FIG. 20, which includes various components operable, configured, or adapted to perform the method 1700. Communications device 2000 is described below in further detail.

Note that FIG. 17 is just one example of a method, and other methods including fewer, additional, or alternative steps are possible consistent with this disclosure.

### Example Operations of a User Equipment

FIG. 18 shows an example of a method 1800 for wireless communications at a UE, such as a UE 104 of FIGS. 1 and 3.

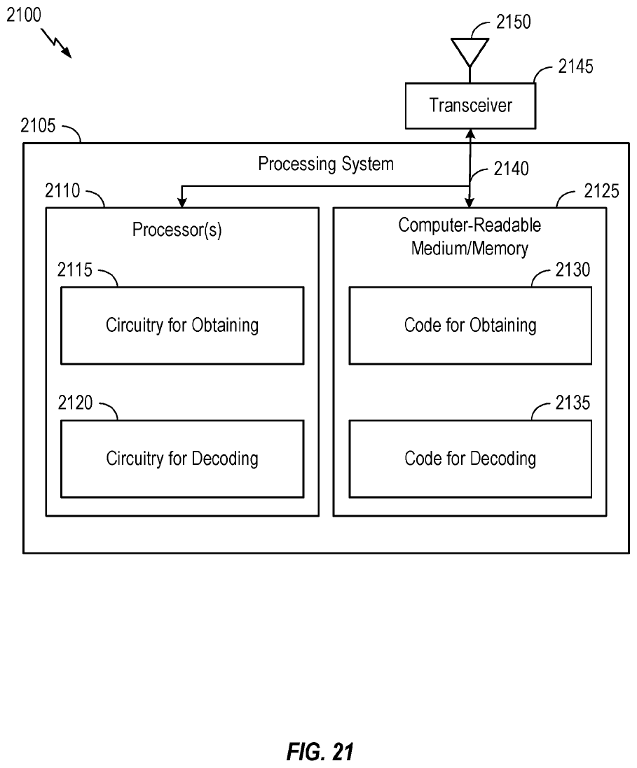

Method 1800 begins at step 1805 with obtaining, from a network entity, signaling indicating a secret-key. In some cases, the operations of this step refer to, or may be performed by, circuitry for obtaining and/or code for obtaining as described with reference to FIG. 21.

Method 1800 then proceeds to step 1810 with obtaining, from the network entity, AN signal. In some cases, the operations of this step refer to, or may be performed by, circuitry for obtaining and/or code for obtaining as described with reference to FIG. 21.

Method 1800 then proceeds to step 1815 with obtaining, from the network entity, a data signal via an RIS. In some cases, the operations of this step refer to, or may be performed by, circuitry for obtaining and/or code for obtaining as described with reference to FIG. 21.

Method 1800 then proceeds to step 1820 with decoding the obtained data signal and the obtained AN signal, in accordance with the secret-key. In some cases, the operations of this step refer to, or may be performed by, circuitry for decoding and/or code for decoding as described with reference to FIG. 21.

In some aspects, the obtaining of the data signal further comprises applying a time phase ramp to shift a frequency domain of the data signal to overlap or align with a frequency domain of the AN signal.

In some aspects, the time phase ramp is based on the secret-key.

In some aspects, the secret-key is agreed among at least two of the network entity, the UE, and a controller of the RIS.

In some aspects, at least one of the time phase ramp or a location of the data signal and the AN signal is agreed among at least two of the network entity, the UE, and a controller of the RIS.

In some aspects, the obtaining of the data signal further includes obtaining the data signal from the network entity on a first subset of REs of a set of REs; and/or the obtaining of the AN signal further includes obtaining the AN signal from the network entity on a second subset of REs of the set of REs.

In some aspects, the decoding includes cancelling the obtained AN signal, in accordance with the secret-key.

In one aspect, method 1800, or any aspect related to it, may be performed by an apparatus, such as communications device 2100 of FIG. 21, which includes various components operable, configured, or adapted to perform the method 1800. Communications device 2100 is described below in further detail.

Note that FIG. 18 is just one example of a method, and other methods including fewer, additional, or alternative steps are possible consistent with this disclosure.

### Example Operations of a Network Entity

FIG. 19 shows an example of a method 1900 for wireless communications at a network entity, such as a BS 102 of FIGS. 1 and 3, or a disaggregated BS as discussed with respect to FIG. 2.

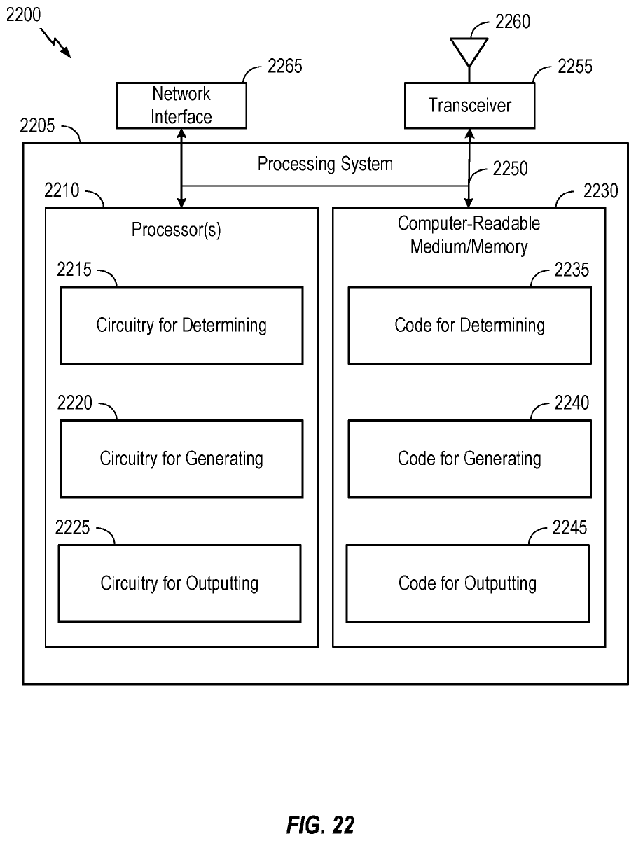

Method 1900 begins at step 1905 with determining a secret-key shared among at least two of the network entity, a UE, and a controller of at least one RIS. In some cases, the operations of this step refer to, or may be performed by, circuitry for determining and/or code for determining as described with reference to FIG. 22.

Method 1900 then proceeds to step 1910 with generating AN signal, in accordance with the secret-key. In some cases, the operations of this step refer to, or may be performed by, circuitry for generating and/or code for generating as described with reference to FIG. 22.

Method 1900 then proceeds to step 1915 with outputting the AN signal for transmission to the UE. In some cases, the operations of this step refer to, or may be performed by, circuitry for outputting and/or code for outputting as described with reference to FIG. 22.

In some aspects, the method 1900 further includes outputting a data signal for transmission to the UE via the at least one RIS. In some cases, the operations of this step refer to, or may be performed by, circuitry for outputting and/or code for outputting as described with reference to FIG. 22.

In some aspects, the outputting of the data signal further includes outputting the data signal on a first subset of REs of a set of REs; and/or the outputting of the AN signal includes outputting the AN signal on a second subset of REs of the set of REs.

In some aspects, the second subset of REs is the same as the first subset of REs.

In some aspects, the outputting of the AN signal includes outputting the AN signal on non-used REs.

In some aspects, the outputting of the AN signal includes outputting the AN signal orthogonal to a direction of the UE.

In some aspects, the outputting of the AN signal includes outputting the AN signal in a same direction as other AN signals.

In one aspect, method 1900, or any aspect related to it, may be performed by an apparatus, such as communications device 2200 of FIG. 22, which includes various components operable, configured, or adapted to perform the method 1900. Communications device 2200 is described below in further detail.

Note that FIG. 19 is just one example of a method, and other methods including fewer, additional, or alternative steps are possible consistent with this disclosure.

### Example Communications Devices

FIG. 20 depicts aspects of an example communications device 2000. In some aspects, communications device 2000 is a controller of one or more RISs. In some aspects, communications device 2000 is a UE, such as UE 104 described above with respect to FIGS. 1 and 3. In some aspects, communications device 2000 is a network entity, such as BS 102 of FIGS. 1 and 3, or a disaggregated BS as discussed with respect to FIG. 2.

The communications device 2000 includes a processing system 2005 coupled to the transceiver 2075 (e.g., a transmitter and/or a receiver). In some aspects (e.g., when communications device 2000 is a network entity), processing system 2005 may be coupled to a network interface 2085 that is configured to obtain and send signals for the communications device 2000 via communication link(s), such as a backhaul link, midhaul link, and/or fronthaul link as described herein, such as with respect to FIG. 2. The transceiver 2075 is configured to transmit and receive signals for the communications device 2000 via the antenna 2080, such as the various signals as described herein. The processing system 2005 may be configured to perform processing functions for the communications device 2000, including processing signals received and/or to be transmitted by the communications device 2000.

The processing system 2005 includes one or more processors 2010. In various aspects, the one or more processors 2010 may be representative of one or more of receive processor 358, transmit processor 364, TX MIMO processor 366, and/or controller/processor 380, as described with respect to FIG. 3. In various aspects, one or more processors 2010 may be representative of one or more of receive processor 338, transmit processor 320, TX MIMO processor 330, and/or controller/processor 340, as described with respect to FIG. 3. The one or more processors 2010 are coupled to a computer-readable medium/memory 2040 via a bus 2070. In certain aspects, the computer-readable medium/memory 2040 is configured to store instructions (e.g., computer-executable code) that when executed by the one or more processors 2010, cause the one or more processors 2010 to perform the method 1700 described with respect to FIG. 17, or any aspect related to it. Note that reference to a processor performing a function of communications device 2000 may include one or more processors 2010 performing that function of communications device 2000.

In the depicted example, computer-readable medium/memory 2040 stores code (e.g., executable instructions), such as code for obtaining 2045, code for configuring 2050, code for selecting 2055, code for changing 2060, and code for applying 2065. Processing of the code for obtaining 2045, code for configuring 2050, code for selecting 2055, code for changing 2060, and code for applying 2065 may cause the communications device 2000 to perform the method 1700 described with respect to FIG. 17, or any aspect related to it.

The one or more processors 2010 include circuitry configured to implement (e.g., execute) the code stored in the computer-readable medium/memory 2040, including circuitry such as circuitry for obtaining 2015, circuitry for configuring 2020, circuitry for selecting 2025, circuitry for changing 2030, and circuitry for applying 2035. Processing with circuitry for obtaining 2015, circuitry for configuring 2020, circuitry for selecting 2025, circuitry for changing 2030, and circuitry for applying 2035 may cause the communications device 2000 to perform the method 1700 described with respect to FIG. 17, or any aspect related to it.

Various components of the communications device 2000 may provide means for performing the method 1700 described with respect to FIG. 17, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 2075 and the antenna 2080 of the communications device 2000 in FIG. 20. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the circuitry for obtaining 2015, the code for obtaining 2045, the transceiver 2075 and the antenna 2080 of the communications device 2000 in FIG. 20. Means for configuring may include receive processor 358, controller/processor 380, and/or transmit processor 364 of the UE 104 illustrated in FIG. 3; receive processor 338, controller/processor 340, and/or transmit processor 320 of the BS 102 illustrated in FIG. 3; and/or the circuitry for configuring 2020, the code for configuring 2050, the processing system 2005, and the transceiver 2075 of the communications device 2000 in FIG. 20. Means for selecting may include receive processor 358, controller/processor 380, and/or transmit processor 364 of the UE 104 illustrated in FIG. 3; receive processor 338, controller/processor 340, and/or transmit processor 320 of the BS 102 illustrated in FIG. 3; and/or the circuitry for selecting 2025, the code for selecting 2055, the processing system 2005, and the transceiver 2075 of the communications device 2000 in FIG. 20. Means for changing may include receive processor 358, controller/processor 380, and/or transmit processor 364 of the UE 104 illustrated in FIG. 3; receive processor 338, controller/processor 340, and/or transmit processor 320 of the BS 102 illustrated in FIG. 3; and/or the circuitry for changing 2030, the code for changing 2060, the processing system 2005, and the transceiver 2075 of the communications device 2000 in FIG. 20. Means for applying may include receive processor 358, controller/processor 380, and/or transmit processor 364 of the UE 104 illustrated in FIG. 3; receive processor 338, controller/processor 340, and/or transmit processor 320 of the BS 102 illustrated in FIG. 3; and/or the circuitry for applying 2035, the code for applying 2065, the processing system 2005, and the transceiver 2075 of the communications device 2000 in FIG. 20.

FIG. 21 depicts aspects of an example communications device 2100. In some aspects, communications device 2100 is a UE, such as UE 104 described above with respect to FIGS. 1 and 3.

The communications device 2100 includes a processing system 2105 coupled to the transceiver 2145 (e.g., a transmitter and/or a receiver). The transceiver 2145 is configured to transmit and receive signals for the communications device 2100 via the antenna 2150, such as the various signals as described herein. The processing system 2105 may be configured to perform processing functions for the communications device 2100, including processing signals received and/or to be transmitted by the communications device 2100.

The processing system 2105 includes one or more processors 2110. In various aspects, the one or more processors 2110 may be representative of one or more of receive processor 358, transmit processor 364, TX MIMO processor 366, and/or controller/processor 380, as described with respect to FIG. 3. The one or more processors 2110 are coupled to a computer-readable medium/memory 2125 via a bus 2140. In certain aspects, the computer-readable medium/memory 2125 is configured to store instructions (e.g., computer-executable code) that when executed by the one or more processors 2110, cause the one or more processors 2110 to perform the method 1800 described with respect to FIG. 18, or any aspect related to it. Note that reference to a processor performing a function of communications device 2100 may include one or more processors 2110 performing that function of communications device 2100.

In the depicted example, computer-readable medium/memory 2125 stores code (e.g., executable instructions), such as code for obtaining 2130 and code for decoding 2135. Processing of the code for obtaining 2130 and code for decoding 2135 may cause the communications device 2100 to perform the method 1800 described with respect to FIG. 18, or any aspect related to it.

The one or more processors 2110 include circuitry configured to implement (e.g., execute) the code stored in the computer-readable medium/memory 2125, including circuitry such as circuitry for obtaining 2115 and circuitry for decoding 2120. Processing with circuitry for obtaining 2115 and circuitry for decoding 2120 may cause the communications device 2100 to perform the method 1800 described with respect to FIG. 18, or any aspect related to it.

Various components of the communications device 2100 may provide means for performing the method 1800 described with respect to FIG. 18, or any aspect related to it. For example, means for transmitting, sending or outputting for transmission may include transceivers 354 and/or antenna(s) 352 of the UE 104 illustrated in FIG. 3 and/or the transceiver 2145 and the antenna 2150 of the communications device 2100 in FIG. 21. Means for receiving or obtaining may include transceivers 354 and/or antenna(s) 352 of the UE 104 illustrated in FIG. 3 and/or the circuitry for obtaining 2115, the code for obtaining 2130, the transceiver 2145 and the antenna 2150 of the communications device 2100 in FIG. 21. Means for decoding may include receive processor 358, controller/processor 380, and/or transmit processor 364 of the UE 104 illustrated in FIG. 3 and/or the circuitry for decoding 2120, the code for decoding 2135, the processing system 2105, and the transceiver 2145 of the communications device 2100 in FIG. 21.

FIG. 22 depicts aspects of an example communications device 2200. In some aspects, communications device 2200 is a network entity, such as BS 102 of FIGS. 1 and 3, or a disaggregated base station as discussed with respect to FIG. 2.

The communications device 2200 includes a processing system 2205 coupled to the transceiver 2255 (e.g., a transmitter and/or a receiver) and/or a network interface 2265. The transceiver 2255 is configured to transmit and receive signals for the communications device 2200 via the antenna 2260, such as the various signals as described herein. The network interface 2265 is configured to obtain and send signals for the communications device 2200 via communication link(s), such as a backhaul link, midhaul link, and/or fronthaul link as described herein, such as with respect to FIG. 2. The processing system 2205 may be configured to perform processing functions for the communications device 2200, including processing signals received and/or to be transmitted by the communications device 2200.

The processing system 2205 includes one or more processors 2210. In various aspects, one or more processors 2210 may be representative of one or more of receive processor 338, transmit processor 320, TX MIMO processor 330, and/or controller/processor 340, as described with respect to FIG. 3. The one or more processors 2210 are coupled to a computer-readable medium/memory 2230 via a bus 2250. In certain aspects, the computer-readable medium/memory 2230 is configured to store instructions (e.g., computer-executable code) that when executed by the one or more processors 2210, cause the one or more processors 2210 to perform the method 1900 described with respect to FIG. 19, or any aspect related to it. Note that reference to a processor of communications device 2200 performing a function may include one or more processors 2210 of communications device 2200 performing that function.

In the depicted example, the computer-readable medium/memory 2230 stores code (e.g., executable instructions), such as code for determining 2235, code for generating 2240, and code for outputting 2245. Processing of the code for determining 2235, code for generating 2240, and code for outputting 2245 may cause the communications device 2200 to perform the method 1900 described with respect to FIG. 19, or any aspect related to it.

The one or more processors 2210 include circuitry configured to implement (e.g., execute) the code stored in the computer-readable medium/memory 2230, including circuitry such as circuitry for determining 2215, circuitry for generating 2220, and circuitry for outputting 2225. Processing with circuitry for determining 2215, circuitry for generating 2220, and circuitry for outputting 2225 may cause the communications device 2200 to perform the method 1900 as described with respect to FIG. 19, or any aspect related to it.

Various components of the communications device 2200 may provide means for performing the method 1900 as described with respect to FIG. 19, or any aspect related to it. Means for transmitting, sending or outputting for transmission may include transceivers 332 and/or antenna(s) 334 of the BS 102 illustrated in FIG. 3 and/or the circuitry for outputting 2225, the code for outputting 2245, the transceiver 2255 and the antenna 2260 of the communications device 2200 in FIG. 22. Means for receiving or obtaining may include transceivers 332 and/or antenna(s) 334 of the BS 102 illustrated in FIG. 3 and/or the transceiver 2255 and the antenna 2260 of the communications device 2200 in FIG. 22. Means for determining may include receive processor 338, controller/processor 340, and/or transmit processor 320 of the BS 102 illustrated in FIG. 3 and/or the circuitry for determining 2215, the code for determining 2235, the processing system 2205, and the transceiver 2255 of the communications device 2200 in FIG. 22. Means for generating may include receive processor 338, controller/processor 340, and/or transmit processor 320 of the BS 102 illustrated in FIG. 3 and/or the circuitry for generating 2220, the code for generating 2240, the processing system 2205, and the transceiver 2255 of the communications device 2200 in FIG. 22.

### Example Clauses

Implementation examples are described in the following numbered clauses:

Clause 1: A method for wireless communications at a controller, comprising: obtaining, from a network entity, signaling indicating a configuration for a security signature for at least one RIS; and configuring the at least one RIS according to the security signature.

Clause 2: The method of Clause 1, wherein the security signature is a random signature based on a first secret-key.

Clause 3: The method of Clause 2, wherein the first secret-key is agreed among at least two of the controller, the network entity, and a UE.

Clause 4: The method of Clause 3, further comprising: obtaining a data signal from the network entity; and applying a time phase ramp to shift a frequency domain of the data signal to overlap or align with a frequency domain of another signal, and wherein the other signal is AN signal.

Clause 5: The method of Clause 4, wherein, at least one of: the obtaining comprises obtaining the data signal from the network entity on a first subset of REs of a set of REs; the AN signal is obtained via a second subset of REs of the set of REs; or the AN signal is also based on the first secret-key.

Clause 6: The method of Clause 4, wherein at least one of the time phase ramp or a location of the data signal and the AN signal are agreed among the network entity, the UE, and the controller.

Clause 7: The method of Clause 2, further comprising: selecting an RIS beamformer from a set of RIS beamformers, in accordance with the security signature.

Clause 8: The method of Clause 2, further comprising: selecting at least one of an amplitude value or a phase value of one or more elements of the at least one RIS, in accordance with the security signature.

Clause 9: The method of Clause 8, further comprising: changing at least one of the amplitude value or the phase value over a duration of at least one symbol, in accordance with the security signature.

Clause 10: The method of Clause 8, further comprising: changing at least one of the amplitude value or the phase value within a first duration of a symbol or a second duration between two symbols, in accordance with the security signature.

Clause 11: The method of Clause 8, further comprising: changing at least one of the amplitude value or the phase value each sample time, in accordance with the security signature.

Clause 12: The method of Clause 8, further comprising: changing at least one of the amplitude value or the phase value every block of symbols, in accordance with the security signature.

Clause 13: The method of Clause 8, further comprising: changing the phase value based on the first secret-key; and changing the amplitude value based on a second secret-key, wherein the second secret-key is different than the first secret-key.

Clause 14: The method of any one of Clauses 1-13, further comprising: randomly turning ON or OFF one or more elements of the at least one RIS, in accordance with the security signature; and selecting at least one of an amplitude value or a phase value of the one or more elements that are turned ON, in accordance with the security signature.

Clause 15: The method of any one of Clauses 1-14, further comprising: randomly turning ON or OFF one or more other RISs in accordance with the security signature; and selecting at least one of an amplitude value or a phase value of one or more elements of the one or more other RISs that are turned ON, in accordance with the security signature.

Clause 16: A method for wireless communications at a UE, comprising: obtaining, from a network entity, signaling indicating a secret-key; obtaining, from the network entity, AN signal; obtaining, from the network entity, a data signal via an RIS; and decoding the obtained data signal and the obtained AN signal, in accordance with the secret-key.

Clause 17: The method of Clause 16, wherein the obtaining of the data signal further comprises applying a time phase ramp to shift a frequency domain of the data signal to overlap or align with a frequency domain of the AN signal.

Clause 18: The method of Clause 17, wherein the time phase ramp is based on the secret-key Clause 19: The method of Clause 18, wherein the secret-key is agreed among at least two of the network entity, the UE, and a controller of the RIS.

Clause 20: The method of Clause 17, wherein at least one of the time phase ramp or a location of the data signal and the AN signal is agreed among at least two of the network entity, the UE, and a controller of the RIS.

Clause 21: The method of any one of Clauses 16-20, wherein, at least one of: the obtaining of the data signal further comprises obtaining the data signal from the network entity on a first subset of REs of a set of REs; or the obtaining of the AN signal further comprises obtaining the AN signal from the network entity on a second subset of REs of the set of REs.

Clause 22: The method of any one of Clauses 16-21, wherein the decoding comprises cancelling the obtained AN signal, in accordance with the secret-key.

Clause 23: A method for wireless communications at a network entity, comprising: determining a secret-key shared among at least two of the network entity, a UE, and a controller of at least one RIS; generating AN signal, in accordance with the secret-key; and outputting the AN signal for transmission to the UE.

Clause 24: The method of Clause 23, further comprising: outputting a data signal for transmission to the UE via the at least one RIS.

Clause 25: The method of Clause 24, wherein, at least one of: the outputting of the data signal further comprises outputting the data signal on a first subset of REs of a set of REs; or the outputting of the AN signal comprises outputting the AN signal on a second subset of REs of the set of REs.

Clause 26: The method of Clause 25, wherein the second subset of REs is the same as the first subset of REs.

Clause 27: The method of Clause 23, wherein the outputting of the AN signal comprises outputting the AN signal on non-used REs.

Clause 28: The method of any one of Clauses 23-27, wherein the outputting of the AN signal comprises outputting the AN signal orthogonal to a direction of the UE.

Clause 29: The method of any one of Clauses 23-28, wherein the outputting of the AN signal comprises outputting the AN signal in a same direction as other AN signals.

Clause 30: An apparatus, comprising: a memory comprising executable instructions; and a processor configured to execute the executable instructions and cause the apparatus to perform a method in accordance with any one of Clauses 1-29.

Clause 31: An apparatus, comprising means for performing a method in accordance with any one of Clauses 1-29.

Clause 32: A non-transitory computer-readable medium comprising executable instructions that, when executed by a processor of an apparatus, cause the apparatus to perform a method in accordance with any one of Clauses 1-29.

Clause 33: A computer program product embodied on a computer-readable storage medium comprising code for performing a method in accordance with any one of Clauses 1-29.

Clause 34: A controller, comprising: at least one transceiver; a memory comprising executable instructions; and a processor configured to execute the executable instructions and cause the controller to perform a method in accordance with any one of Clauses 1-15, wherein the at least one transceiver is configured to receive the signaling from the network entity.

Clause 35: A user equipment (UE), comprising: at least one transceiver; a memory comprising executable instructions; and a processor configured to execute the executable instructions and cause the UE to perform a method in accordance with any one of Clauses 16-22, wherein the at least one transceiver is configured to receive the signaling, the AN signal, and the data signal from the network entity.

Clause 36: A network entity, comprising: at least one transceiver; a memory comprising executable instructions; and a processor configured to execute the executable instructions and cause the network entity to perform a method in accordance with any one of Clauses 23-29, wherein the at least one transceiver is configured to transmit the AN signal to the UE.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining”may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications, comprising:
a memory comprising computer-executable instructions; and
a processor configured to execute the computer-executable instructions and cause the apparatus to:
obtain, from a network entity, signaling indicating a configuration for a security signature for at least one reconfigurable intelligent surface (RIS); and
configure the at least one RIS according to the security signature.

2. The apparatus of claim 1, wherein the security signature is a random signature based on a first secret-key.

3. The apparatus of claim 2, wherein the first secret-key is agreed among at least two of the apparatus, the network entity, and a user equipment (UE).

4. The apparatus of claim 2, wherein the processor is further configured to execute the computer-executable instructions and cause the apparatus to select an RIS beamformer from a set of RIS beamformers, in accordance with the security signature.

5. The apparatus of claim 2, wherein the processor is further configured to execute the computer-executable instructions and cause the apparatus to select at least one of an amplitude value or a phase value of one or more elements of the at least one RIS, in accordance with the security signature.

6. The apparatus of claim 5, wherein at least one of:
the processor is further configured to execute the computer-executable instructions and cause the apparatus to change at least one of the amplitude value or the phase value over a duration of at least one symbol, in accordance with the security signature;
the processor is further configured to execute the computer-executable instructions and cause the apparatus to change at least one of the amplitude value or the phase value within a first duration of a symbol or a second duration between two symbols, in accordance with the security signature;
the processor is further configured to execute the computer-executable instructions and cause the apparatus to change at least one of the amplitude value or the phase value each sample time, in accordance with the security signature;
the processor is further configured to execute the computer-executable instructions and cause the apparatus to change at least one of the amplitude value or the phase value every block of symbols, in accordance with the security signature; or
the processor is further configured to execute the computer-executable instructions and cause the apparatus to change the phase value based on the first secret-key and change the amplitude value based on a second secret-key, wherein the second secret-key is different than the first secret-key.

7-9. (canceled)

10. The apparatus of claim 5, wherein the processor is further configured to execute the computer-executable instructions and cause the apparatus to:
change the phase value based on the first secret-key; and
change the amplitude value based on a second secret-key, wherein the second secret-key is different than the first secret-key.

11. The apparatus of claim 1, wherein the processor is further configured to execute the computer-executable instructions and cause the apparatus to:
randomly turn ON or OFF one or more elements of the at least one RIS, in accordance with the security signature; and
select at least one of an amplitude value or a phase value of the one or more elements that are turned ON, in accordance with the security signature.

12. The apparatus of claim 1, wherein the processor is further configured to execute the computer-executable instructions and cause the apparatus to:
randomly turn ON or OFF one or more other RISs in accordance with the security signature; and
select at least one of an amplitude value or a phase value of one or more elements of the one or more other RISs that are turned ON, in accordance with the security signature.

13. The apparatus of claim 3, wherein the processor is further configured to execute the computer-executable instructions and cause the apparatus to:
obtain a data signal from the network entity; and
apply a time phase ramp to shift a frequency domain of the data signal to overlap or align with a frequency domain of another signal, and wherein the other signal is an artificial noise (AN) signal.

14. The apparatus of claim 13, wherein, at least one of:
the obtain the data signal comprises obtain the data signal from the network entity on a first subset of resource elements (REs) of a set of REs;
the AN signal is obtained via a second subset of REs of the set of REs;
the AN signal is also based on the first secret-key; or
at least one of the time phase ramp or a location of the data signal and the AN signal are agreed among the network entity, the UE, and the apparatus.

15. (canceled)

16. An apparatus for wireless communications, comprising:
a memory comprising computer-executable instructions; and
a processor configured to execute the computer-executable instructions and cause the apparatus to:
obtain, from a network entity, signaling indicating a secret-key;
obtain, from the network entity, an artificial noise (AN) signal;
obtain, from the network entity, a data signal via a reconfigurable intelligent surface (RIS); and
decode the obtained data signal and the obtained AN signal, in accordance with the secret-key.

17. The apparatus of claim 16, wherein the obtaining of the data signal further comprises applying a time phase ramp to shift a frequency domain of the data signal to overlap or align with a frequency domain of the AN signal.

18. The apparatus of claim 17, wherein at least one of:
the time phase ramp is based on the secret-key; or
the secret-key is agreed among at least two of the network entity, the apparatus, and a controller of the RIS.

19. (canceled)

20. The apparatus of claim 16, wherein, at least one of:
the obtaining of the data signal further comprises obtaining the data signal from the network entity on a first subset of resource elements (REs) of a set of REs;
the obtaining of the AN signal further comprises obtaining the AN signal from the network entity on a second subset of REs of the set of REs; or
the decoding comprises cancelling the obtained AN signal, in accordance with the secret-key.

21. The apparatus of claim 17, wherein at least one of the time phase ramp or a location of the data signal and the AN signal is agreed among at least two of the network entity, the apparatus, and a controller of the RIS.

22. (canceled)

23. An apparatus for wireless communications, comprising:
a memory comprising computer-executable instructions; and
a processor configured to execute the computer-executable instructions and cause the apparatus to:
determine a secret-key shared among at least two of the apparatus, a user equipment (UE), and a controller of at least one reconfigurable intelligent surface (RIS);
generate an artificial noise (AN) signal, in accordance with the secret-key; and
output the AN signal for transmission to the UE.

24. The apparatus of claim 23, wherein the processor is further configured to execute the computer-executable instructions and cause the apparatus to output a data signal for transmission to the UE via the at least one RIS.

25. The apparatus of claim 24, wherein, at least one of:
the output of the data signal further comprises outputting the data signal on a first subset of resource elements (REs) of a set of REs;
the output of the AN signal comprises outputting the AN signal on a second subset of RES of the set of REs;
the output of the AN signal comprises outputting the AN signal orthogonal to a direction of the UE;
the output of the AN signal comprises outputting the AN signal in a same direction as other AN signals; or
the output of the AN signal comprises outputting the AN signal on one or more non-used resource elements (REs).

26. (canceled)

27. The apparatus of claim 25, wherein the second subset of REs is the same as the first subset of REs.

28-30. (canceled)
